(19) United States
(12) Patent Application Publication
(10) Pub. No.: US 2021/0321582 A1
(43) Pub. Date: Oct. 21, 2021

(54) CLOG RESISTANT PRESSURE COMPENSATING NOZZLE FOR DRIP IRRIGATION

(71) Applicant: DLHBOWLES, INC., Canton, OH (US)

(72) Inventors: Evan Hartranft, Canton, OH (US); Luis Niquet, Bloomington, MN (US); Reza Ronaghian, Canton, OH (US)

(21) Appl. No.: 17/232,899

(22) Filed: Apr. 16, 2021

Related U.S. Application Data
(60) Provisional application No. 63/010,857, filed on Apr. 16, 2020.

(51) Int. Cl. A01G 25/02; B05B 15/40; B05B 12/08

(52) U.S. Cl. CPC A01G 25/023; A01G 25/06; B05B 12/088; B05B 15/40

(57) ABSTRACT

A clog resistant in-line irrigation emitter or nozzle assembly having an emitter structure designed to be inserted into an extruded tube as part of a drip irrigation system. The nozzle assemblies take the high pressure and flow inside the tube and produce a desired flowrate (selectable depending on the requirements of the environment). The emitter of the present disclosure has a higher efficiency than traditional pivot or sprinkler systems or known emitter devices. The emitters not only provide the appropriate pressure attenuation; they resist clogging from the grit and debris in available ground water. The clog resistant in-line irrigation emitter gives a greater pressure attenuation for its physical dimensions than comparable devices and provides an optimal design of a pressure compensating device that improves diaphragm performance. The instant disclosure does allow for the pressure compensation device to be used with various embodiments of a pressure reducing components.

### CROSS-REFERENCE TO RELATED APPLICATIONS

This application claims the benefit of and the priority to U.S. Provisional Patent No. 63/010,857 entitled “CLOG RESISTANT PRESSURE COMPENSATING NOZZLE FOR DRIP IRRIGATION,” filed on Apr. 16, 2020. This application is also related to U.S. patent application Ser. NO. 16/001,432 entitled “CLOG RESISTANT IN-LINE VORTEX ELEMENT IRRIGATION EMITTER,” filed on Jun. 6, 2018 which claims priority to and the benefit of U.S. Provisional Application No. 62/515,973 entitled “CLOG RESISTANT IN-LINE VORTEX ELEMENT IRRIGATION EMITTER,” filed on Jun. 6, 2017, each are hereby incorporated by reference in their entirety.

### FIELD OF THE DISCLOSURE

The present disclosure pertains generally to devices for use as drip irrigation emitters. More particularly, the present disclosure pertains to drip irrigation emitters that provide a substantially constant drip flow-rate over a wide range of line pressures. The present disclosure is particularly, but not exclusively, useful as a self-cleaning, pressure compensating, irrigation drip emitter optimized for assemblies having multiple irrigation drip emitters with improved clog resistance and self-flushing features that are configured to be mounted to a supply tube to form an irrigation assembly or system.

### BACKGROUND

Drip emitters are commonly used in irrigation systems to convert water flowing through a supply tube at a relatively high flow rate to a relatively low flow rate at the outlet of each emitter. Each drip emitter generally includes a housing defining a flow path that reduces high pressure water entering the drip emitter into relatively low pressure water exiting the drip emitter. Multiple drip emitters are commonly mounted on the inside or outside of a water supply tube. In one type of system, a large number of drip emitters are mounted at regular and predetermined intervals along the length of the supply tube to distribute water at precise points to surrounding land and vegetation. These emitters may either be mounted internally (i.e., in-line emitters) or externally (i.e., on-line or branch emitters). Some advantages to in-line emitters are that the emitter units are less susceptible to being knocked loose from the fluid carrying conduit and the conduit can be buried underground if desired (i.e., subsurface emitters) which further makes it difficult for the emitter to be inadvertently damaged (e.g., by way of being hit or kicked by a person, hit by a lawnmower or trimmer, etc.).

Traditional prior art drip emitters containing moving parts and pressure compensating flexible membranes have one side of the membrane exposed to irrigation line pressure, while the opposite side of the membrane is exposed to a reduced pressure. Pressure compensating heavy walled drip lines, such as those disclosed by U.S. Published Patent Application No. 2005/0284966 provides an innovative self-flushing emitter design as illustrated by FIG. 1 which is incorporated by reference. Here, the reduced pressure can be created by forcing a portion of the water from the irrigation line through a restrictor or labyrinth. This pressure differential on opposite sides of the membrane causes the flexible membrane to deform. In particular, the higher line pressure can be used to force the flexible membrane into a slot where reduced pressure water is flowing. As the line pressure increases, the membrane will be pressed further into the slot, decreasing the effective cross-section of the slot and thus restricting flow through the slot.

There is a recognized market need to improve clog resistance of drip irrigation emitter nozzles while also capable of using a plurality of emitter nozzles in a dynamic fluidic system. However, existing prior art drip emitters are not as effective and economical as is desired and there is a need for an economical, scalable, effective fluidic equipped drip irrigation devices suitable for the purposes of providing a constant drip flow in response to a varying line pressure that reduces risk of clogging. Further, many known emitters have a limited expected service life in which the intended users, such as farmers, must replace upstream filters to prevent the emitters and nozzles from failing. It would be desirable to provide an improved emitter design that can provide for a relatively constant water output from each of the emitters in the irrigation system. More specifically, it is desirable to provide pressure compensation so as to ensure that the flow rate of the first emitter in the system is substantially the same as the last emitter in the system. Without such flow rate compensation, the last emitter in a series of emitters will experience a greater pressure loss than the first. Such pressure loss results in the inefficient and wasteful use of water.

### SUMMARY

Accordingly, it is an object of the present disclosure to overcome the above mentioned difficulties by providing a clog resistant in-line irrigation emitter or irrigation dripper which is easy to use, relatively simple to manufacture, and comparatively cost effective to install, and over its life cycle. The emitter structure of the present disclosure may be designed to be injection molded as a component and then inserted into an extruded tube as part of a drip irrigation system. The drip irrigation assembly's tube may be placed in a farm field and fluid may be pumped in. The emitters take the high pressure and flow inside the tube and produce a desired flowrate (selectable depending on the requirements of the environment, terrain or plant being irrigated). The emitter of the present disclosure has a higher efficiency than traditional pivot or sprinkler systems or known emitter devices. The emitters not only provide the appropriate pressure attenuation; they resist clogging from the grit and debris in available ground water.

In accordance with the present disclosure, a newly developed prototype clog resistant in-line irrigation emitter or nozzle assembly gives improved clog resistance and self-flushing features for its physical dimensions than comparable devices in the prior art (as described above). The design of the present disclosure includes an optimal design of a pressure compensating device. The instant disclosure does allow for the pressure compensation device to be used with various embodiments of a pressure reducing assembly.

In one embodiment, provided is an emitter nozzle assembly for an in-line irrigation tube comprising a backing plate that includes an outlet; a pressure reducing component that includes an emitter circuit having a plurality of chambers defined along a first side and a second side of a unitary body in fluid communication with one another; a cover plate that includes a filter component in fluid communication with the pressure reducing component; and a pressure compensating component in fluid communication with the pressure reducing component and filter component. The pressure compensating component comprising a cavity that includes a platform positioned along a base of the cavity, the platform that includes a platform surface, a weir channel, and an exit hole, wherein the exit hole is in fluid communication with the outlet. A diagram is provided with a first surface and an opposite second surface, the diaphragm is positioned in the cavity and configured to separate the cavity into a first zone adjacent the first surface and in direct fluid communication with the filter component and a second zone adjacent the second surface and in direct fluid communication with the exit hole, the diaphragm configured to deflect between a neutral position and a contact position against the platform surface. The diaphragm may be positioned within the cavity and includes a land height dimension between the second surface and the platform surface that is equal to or greater than at least 1.2 mm when the diaphragm is in the neutral position within the cavity.

In an embodiment, the pressure compensating component further includes an outlet lumen that includes an inlet configured to receive fluid from the plurality of chambers of the pressure reducing component and an outlet positioned in the cavity, wherein the outlet lumen provides fluid communication between the pressure compensating component and the pressure reducing component and wherein the inlet and the outlet of the outlet lumen are aligned along a common axis with the exit hole and weir channel of the platform within the cavity. The weir channel may include a weir geometry having an angled floor relative to the landing surface and notched portion relative to the outlet. The weir channel may include a weir depth within a dimensional range of between about 0.05 mm to about 0.15 mm. The backing plate includes a cavity that is shaped and configured to receive and support the pressure reducing component within the cavity. Further, each of the plurality of chambers of the emitter circuit may include an inlet region, a power nozzle, an interaction region and a throat having dimensions to create a pressure drop of fluid flow therein. The emitter nozzle assembly is configured to be attached to an inner surface of an in-line irrigation tube. Also provided is an in-line irrigation tube system comprising a plurality of emitter nozzle assemblies that further comprising a tube having an inner surface wherein the plurality of emitter nozzle assemblies are positioned along said inner surface of said tube.

In another embodiment, provided is an emitter nozzle assembly for an in-line irrigation tube comprising a backing plate that includes an outlet; a pressure reducing component that includes a body with an emitter circuit defined therein having a multi-lumen flow channel between and inlet and an outlet providing fluid communication between the inlet and the outlet wherein said body is configured as a double-sided circuit and a plurality of chambers with lumens aligned in series; a cover plate that includes a filter component in fluid communication with the pressure reducing component; and a pressure compensating component in fluid communication with the pressure reducing component and filter component. The pressure compensating component comprising a cavity that includes a platform positioned along a base of the cavity, the platform that includes a platform surface, a weir channel, and an exit hole, wherein the exit hole is in fluid communication with the outlet of the backing plate; a diagram with a first surface and an opposite second surface, the diaphragm is positioned in the cavity and configured to separate the cavity into a first zone adjacent the first surface that is in direct fluid communication with the filter component and a second zone adjacent the second surface that is in direct fluid communication with the exit hole, the diaphragm configured to deflect between a neutral position and a contact position against the platform surface; and an outlet lumen that includes an inlet configured to receive fluid from the plurality of chambers of the pressure reducing component and an outlet positioned in the cavity, wherein the outlet lumen provides fluid communication between the pressure compensating component and the pressure reducing component and wherein the inlet and the outlet of the outlet lumen are aligned along a common axis with the exit hole and weir channel of the platform within the cavity.

The diaphragm may be positioned within the cavity and may include a land height dimension between the second surface and the platform surface that is equal to or greater than at least 1.2mm when the diaphragm is in the neutral position within the cavity. The emitter nozzle assembly may be configured to be attached to an inner surface of an in-line irrigation tube such that the outlet of the backing plate is aligned with a through hole of the irrigation tube to allow a flow of fluid to be dispensed therefrom. An in-line irrigation tube system comprising a plurality of emitter nozzle assemblies having a tube with an inner surface wherein the plurality of emitter nozzle assemblies are positioned along said inner surface of said tube. The weir channel includes a weir geometry having an angled floor relative to the landing surface and notched portion relative to the outlet. The weir channel includes a weir depth that may be within a dimensional range of between about 0.05 mm to about 0.15 mm. The backing plate may include a cavity that is shaped and configured to receive and support the pressure reducing component within the cavity. Further, each of the plurality of chambers of the emitter circuit may include an inlet region, a power nozzle, an interaction region and a throat having dimensions to create a pressure drop of fluid flow therein. The emitter nozzle assembly may be configured to be attached to an inner surface of an in-line irrigation tube.

In yet another embodiment, provided is an emitter nozzle assembly for an in-line irrigation tube comprising: a backing plate that includes an outlet; a pressure reducing component that includes an emitter circuit having a plurality of chambers defined along a first side and a second side of a unitary body in fluid communication with one another; a cover plate that includes a filter component in fluid communication with the pressure reducing component; and a pressure compensating component in fluid communication with the pressure reducing component and filter component, the pressure compensating component comprising: a cavity that includes a platform positioned along a base of the cavity, the platform that includes a platform surface, a weir channel, and an exit hole, wherein the exit hole is in fluid communication with the outlet; a diagram with a first surface and an opposite second surface, the diaphragm is positioned in the cavity and configured to separate the cavity into a first zone adjacent the first surface and in direct fluid communication with the filter component and a second zone adjacent the second surface and in direct fluid communication with the exit hole, the diaphragm configured to deflect between a neutral position and a contact position against the platform surface; wherein the weir channel includes a weir geometry having an angled floor relative to the landing surface and a notched portion that extends radially outwardly relative to the outlet.

The weir channel may includes a weir depth within a dimensional range of between about 0.05 mm to about 0.15 mm. The nozzle assembly may further comprise an outlet lumen that includes an inlet configured to receive fluid from the plurality of chambers of the pressure reducing component and an outlet positioned in the cavity, wherein the outlet lumen provides fluid communication between the pressure compensating component and the pressure reducing component and wherein the inlet and the outlet of the outlet lumen are aligned along a common axis with the exit hole and weir channel of the platform within the cavity. The diaphragm may be positioned within the cavity and includes a land height dimension between the second surface and the platform surface that is equal to or greater than at least 1.2 mm when the diaphragm is in the neutral position within the cavity.

### BRIEF DESCRIPTION OF THE DRAWINGS

The operation of the present disclosure may be better understood by reference to the following detailed description taken in connection with the following illustrations, wherein:

FIG. 1 is a perspective view of the emitter nozzle assembly disclosed by U.S. Published Patent Application No. 2005/0284966;

FIGS. 2A, 2B, and 2C illustrating embodiments of an emitter nozzle assembly according to embodiments of the instant disclosure;

FIG. 3 is an exploded view of the emitter nozzle assembly of FIG. 2A;

FIG. 4 is an exploded view of the emitter nozzle assembly of FIG. 2B;

FIG. 5 is an exploded view of the emitter nozzle assembly of FIG. 2C;

FIG. 6A is an enlarged cross sectional schematic view of fluid flow directed through an embodiment of the emitter nozzle assembly of the instant disclosure;

FIG. 6B is an enlarged cross sectional schematic view of fluid flow directed through an embodiment of the emitter nozzle assembly of the instant disclosure;

FIG. 6C is an enlarged cross sectional schematic view of fluid flow directed through an embodiment of the emitter nozzle assembly of the instant disclosure;

FIG. 6D is a schematic plan view of fluid flow directed through an embodiment of the emitter nozzle assembly of the instant disclosure;

FIG. 6E is an enlarged cross sectional schematic view of fluid flow directed through an embodiment of the emitter nozzle assembly of the instant disclosure;

FIG. 7A is a cross sectional view of the emitter nozzle assembly positioned within a pipe according to the present disclosure;

FIG. 7B is an enlarged cross sectional view of the emitter nozzle assembly of FIG. 7A;

FIG. 8 is a top view of an embodiment of the emitter nozzle assembly of the instant application;

FIG. 9 is a cross sectional view of FIG. 8 along line AA;

FIG. 10 is a schematic diagram of the pressure compensation assembly of the emitter nozzle assembly of the instant disclosure;

FIG. 11A is a schematic view illustrating the function of a pressure compensation assembly of an emitter nozzle having a low height chamber depth and an illustration identifying relative flow magnitude through said pressure compensation assembly;

FIG. 11B is a schematic view illustrating the function of a pressure compensation assembly of an emitter nozzle having an enlarged height chamber depth and an illustration identifying relative flow magnitude through said pressure compensation assembly;

FIG. 12A is a schematic view of an embodiment of a cavity of the pressure compensation assembly for an emitter nozzle assembly contemplated for the instant application.

FIG. 12B is a schematic view of an embodiment of a cavity of the pressure compensation assembly for an emitter nozzle assembly contemplated for the instant application.

FIG. 12C is a schematic view of an embodiment of a cavity of the pressure compensation assembly for an emitter nozzle assembly contemplated for the instant application.

FIG. 12D is a schematic view of an embodiment of a cavity of the pressure compensation assembly for an emitter nozzle assembly contemplated for the instant application.

FIG. 12E is a schematic view of an embodiment of a cavity of the pressure compensation assembly for an emitter nozzle assembly contemplated for the instant application.

FIG. 12F is a schematic view of an embodiment of a cavity of the pressure compensation assembly for an emitter nozzle assembly contemplated for the instant application.

FIG. 13A is a cross sectional schematic diagram illustrating portions of a pressure compensation assembly of the emitter nozzle assembly of the instant disclosure;

FIG. 13B is schematic pan view illustrating portions of a pressure compensation assembly of the emitter nozzle assembly of the instant disclosure;

FIG. 14 is a graph illustrating pressure (P) and flow rate (Q) data for embodiments of the disclosed emitter assembly including pressure compensating device; and

FIG. 15 is a graph illustrating exponent values of the embodiments of the graph of FIG. 13;

FIG. 16 is a graph illustrating an average flowrate vs grit size for various tested embodiments of emitter nozzle assemblies; and

FIG. 17 is a graph illustrating a grit test conducted for embodiments of the emitter nozzle assembly.

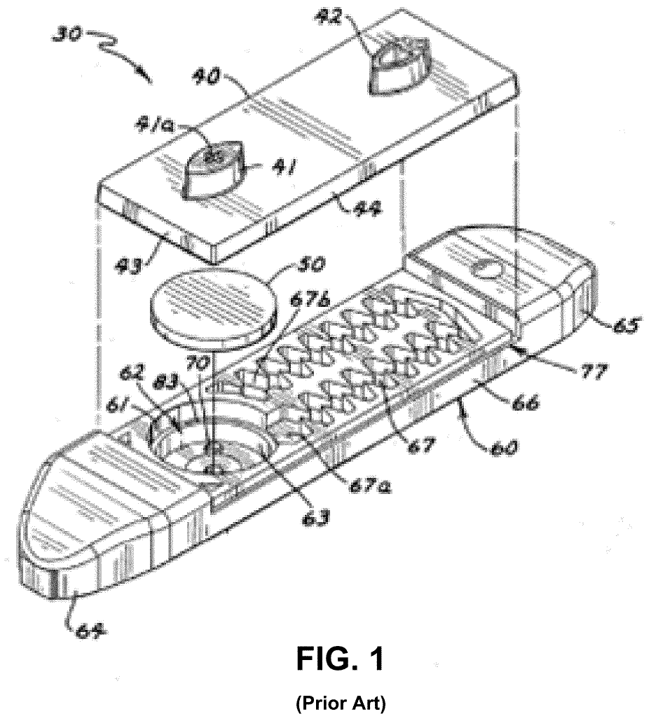

### DETAILED DESCRIPTION

Reference will now be made in detail to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Similar reference numerals are used throughout the figures. Therefore, in certain views, only selected elements are indicated even though the features of the system or assembly may be identical in all of the figures. In the same manner, while a particular aspect of the disclosure is illustrated in these figures, other aspects and arrangements are possible, as will be explained below.

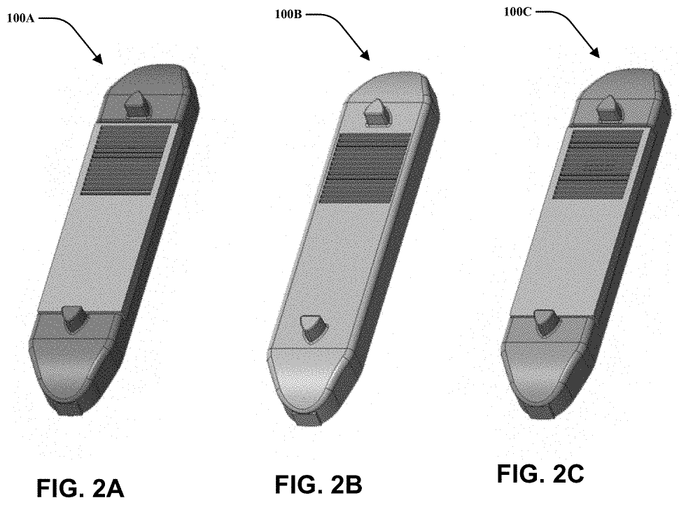

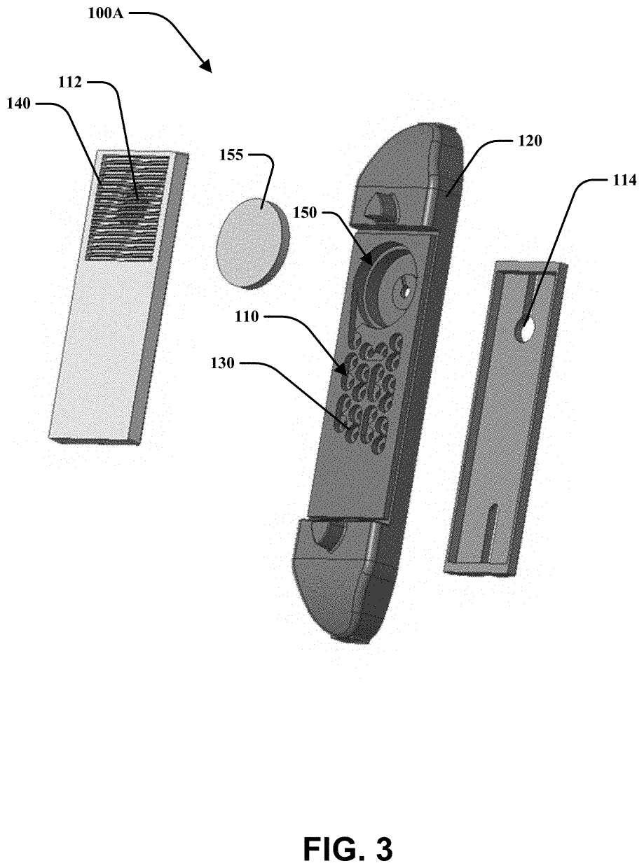

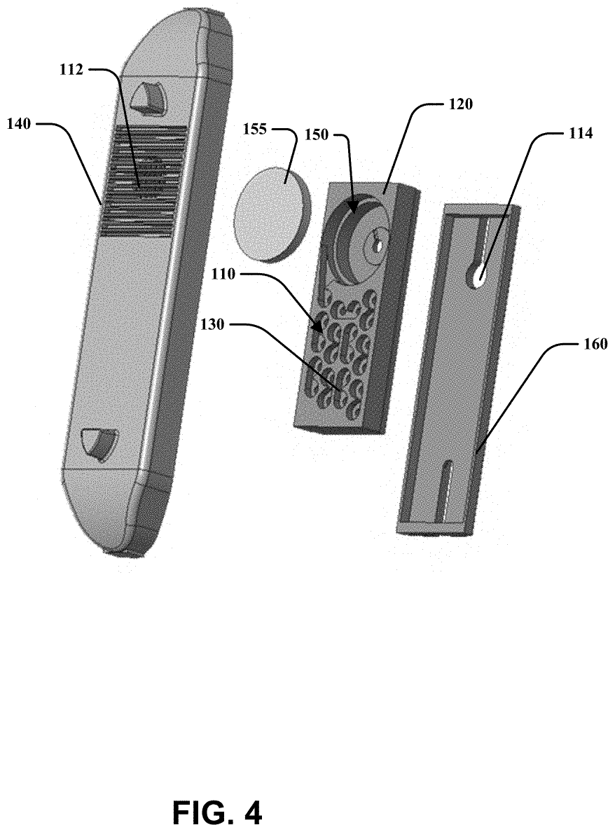

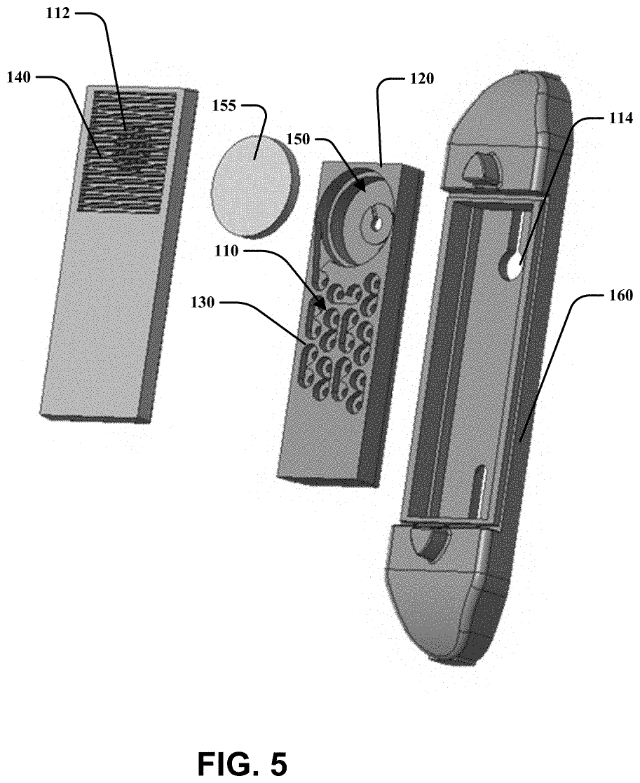

FIGS. 2A, 2B, and 2C illustrate embodiments of an emitter nozzle assemblies as contemplated herein and its components parts. The emitter nozzle assemblies 100 may generally include a pressure reduction component 110, a base or body 120, a cover plate with a filter component 140, a pressure compensating component 150, and a backing or discharge plate 160. In one embodiment, the emitter nozzle assembly 100A of FIG. 2A is illustrated in an exploded configuration in FIG. 3, the emitter nozzle assembly 100B of FIG. 2B is illustrated in an exploded configuration in FIG. 4, and the emitter nozzle assembly 100C of FIG. 2C is illustrated in an exploded configuration in FIG. 5. Each of the embodiments may have different structural configurations but include common functions. For example, the emitter nozzle assemblies may each include a pressure reducing component 110 that includes an emitter circuit defined in a surface of a body 120 that is configured to allow for fluid communication between an inlet 112, an outlet 114. The emitter circuit of the pressure reduction component 110 may be defined in the body 120 with a double-sided surface having a plurality of single or individual chambers 130, each with a flow channel lumen dimensioned to optimize a pressure drop with large lumen dimensions and good clog resistance. One embodiment of such chambers is disclosed by U.S. patent application Ser. NO. 16/001,432, wherein the emitter circuit of the pressure reduction component 110 may include a plurality of vortex emitters type chambers 130 that may be optimized for a dimensionless coefficient of emitter efficiency “Ef” wherein “Ef=(k/Ackt)*Amin. In such an embodiment, the emitter circuit may include a plurality of chambers defined along a first side and a second side of a unitary body in fluid communication with one another. In another embodiment, the body 120 of the pressure reducing component 110 includes the emitter circuit defined therein having a multi-lumen flow channel between an inlet and an outlet providing fluid communication between the inlet and the outlet wherein said body is configured as a double-sided circuit and a plurality of chambers with lumens aligned in series. However, it should be appreciated that the emitter assembly 100 may be operable with various other embodiments of the pressure reducing component 110 and are illustrated as used in only one optional embodiment of the present disclosure which is not limited herein.

The filter component 140 may be any structural configuration that allows fluid to flow therethrough that may catch debris or other particulate prior to flowing through the assembly 100 and the pressure reducing portion 110. The filter component 140 may have various structural configurations and may function to allow fluid to pass through an inlet of the assembly 100 while preventing relatively large grit or particulates located within the pressurized fluid flowing though the tube from entering the assembly 100.

The pressure compensating component 150 may be a moveable device that modifies the pressure and flow of fluid through the assembly 100 in a particular manner in an effort to manage pressure of fluid flow therein. The pressure compensating component 150 may include a gasket or diaphragm 155 and its operation will be disclosed more fully herein.

FIG. 3 illustrates the emitter nozzle assembly 100A wherein the base 120 includes the pressure reducing component 110 and pressure compensating component 150 defined therein while the filter 140 and discharge plate 160 are attached along opposing sides of the base 120. FIG. 4 illustrates the emitter nozzle assembly 100B wherein the filter component 140 is sized to receive the base 120 therein. FIG. 5 illustrates the emitter nozzle assembly 100C wherein the discharge plate 160 is sized to receive the base 120 therein.

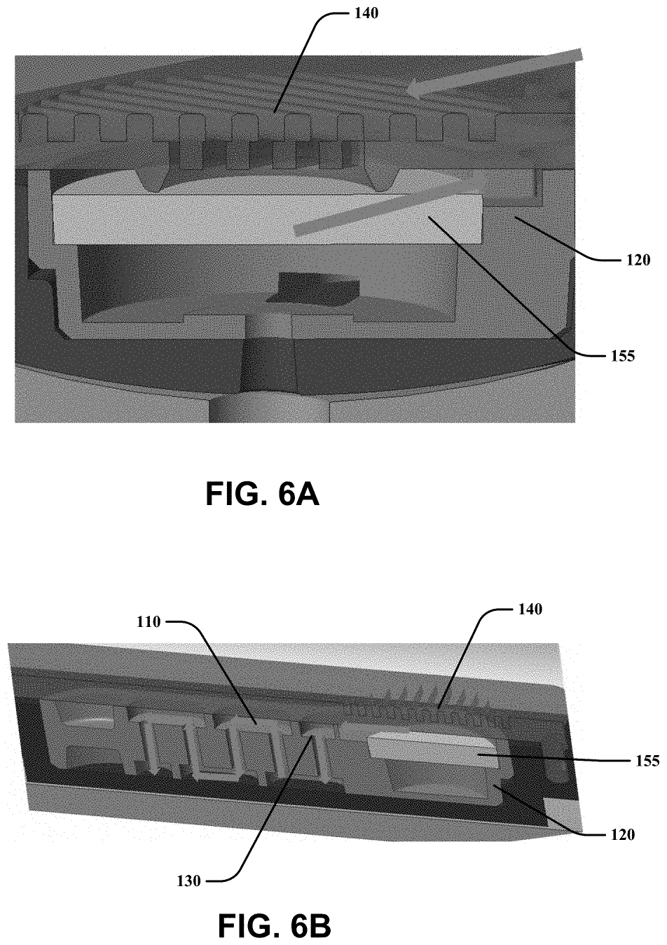

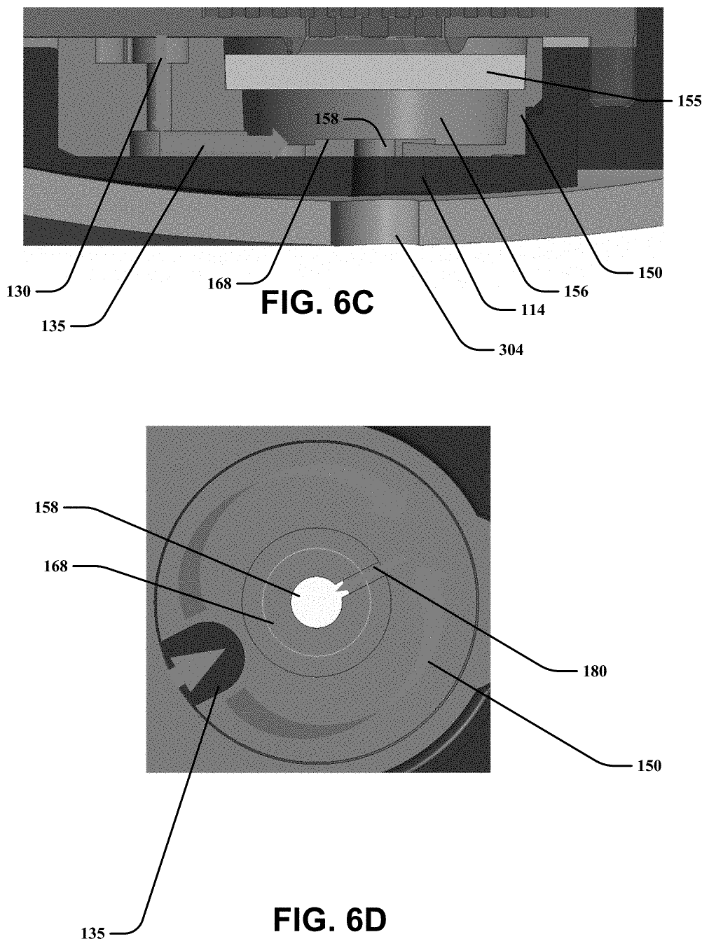

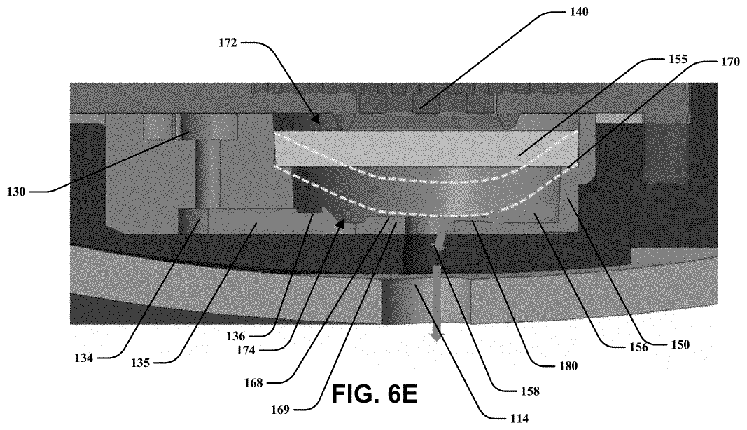

In normal operation, fluid may flow through the assembly 100 from an assembly inlet 112 at the filter component 140, the pressure reduction component 110 and the pressure compensating portion 150 prior to being discharged from the outlet 114 to the environment. As illustrated by FIGS. 6A-6E, fluid may flow through the emitter nozzle assembly 100 by entering through the filter 140 and passing over the diaphragm 155 as illustrated by FIG. 6A. Here, debris or grit may be removed from the fluid and the fluid is directed to abut against the fluid facing side (top) of the diaphragm 155 of the pressure compensating component 150. Fluid then traverses the chambers 130 of the pressure reduction component 110 along the base 120 as illustrated by FIG. 6B. Fluid pressure is reduced by traversing though the chambers 130 until reaching an outlet lumen 135 in direct fluid communication between the pressure reduction portion 110 and the pressure compensating portion 150. Once through the plurality of chambers 130 the flow may enter into a cavity 156 of the pressure compensating component 150 at an opposite (bottom) side of the diaphragm 155. The pressure reduction portion 110 may provide a pressure difference that results in the deformation of the diaphragm 155 (See FIG. 6E) to form a small opening between the deformed diaphragm 155 and an exit hole 158 which is designed to supply a remainder of the head loss to achieve a desired flow rate. The small opening may be considered a weir 180 which is a channel formed in a platform 169 that allows for flow to be distributed through the exit hole 158 and outlet 114 as the diaphragm has been deformed to abut close to or abut upon a platform surface 168 that surrounds the exit hole 158 within the cavity 150. Flow may traverse through the weir 180 and then be distributed through the outlet 114 to environment.

However, grit may clog the flow of fluid through the emitter nozzle assembly 100 and may particularly clog at the weir 180 causing the flow of fluid to stop and pressure to equalize therein. This would cause the diaphragm 155 to flatten or normalize due to the equal pressure though the emitter and thus the grit formed in the weir 180 would unclog and allow fluid to flow through the exit hole 158 and outlet 114 once again. The emitter then returns to normal operation and allow the diaphragm to return to its deformed state.

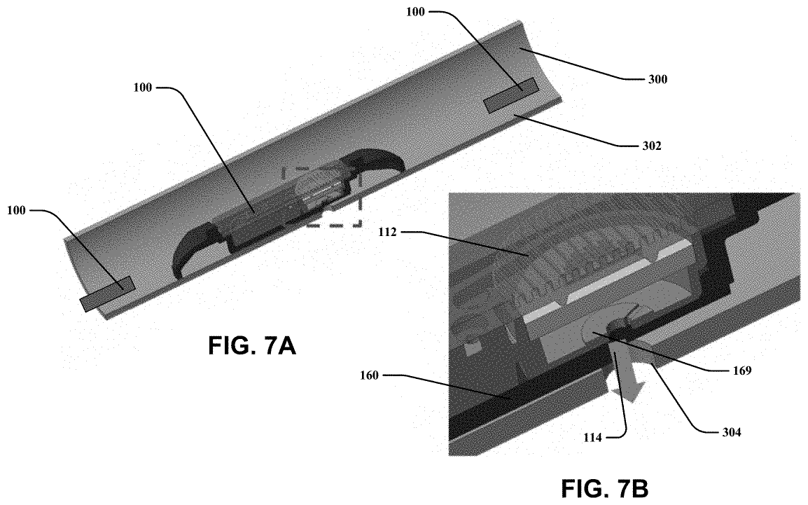

FIGS. 7A and 7B illustrate an embodiment of the emitter nozzle assembly 100 that includes the described pressure reduction component 110 and pressure compensating portion 150 assembled with the filter component 140 and the discharge place 160 and located within a tube 300. The discharge plate 160 along the opposite side of the filter component 140 and the inlet 112 to support the emitter nozzle assembly 100 along an inner surface 302 of the tube 300. The outlet 114 along the discharge plate 150 is in fluid communication with an outlet 304 along the tube 300 to allow fluid to be dispensed to the environment. Notably, FIG. 7A illustrates conceptually that a plurality of emitter nozzle assemblies 100 may be attached to the inner surface of an irrigation tube to be used in a comprehensive irrigation system to assist with pressurization, consistency of flow rate, and clog reduction as disclosed herein.

The performance of the disclosed assembly has been optimized based on the configuration of the components within the cavity of the pressure compensation component 150. The pressure compensating component 150 may include the cavity 156 that includes a shoulder 170 for supporting the diaphragm 155. The shoulder 170 may be an annular shape and the diaphragm 155 may be a complementary shape to fit within a portion of the cavity 156 to separate the cavity 156 into a first zone 172 in direct fluid communication with the filter 140 and a second zone 174 in direct fluid communication with the outlet 114. The diaphragm 155 may include a first surface 178 and an opposite second surface 182 where the first surface 178 is within the first zone 172 and the second surface 182 is within the second zone 182.

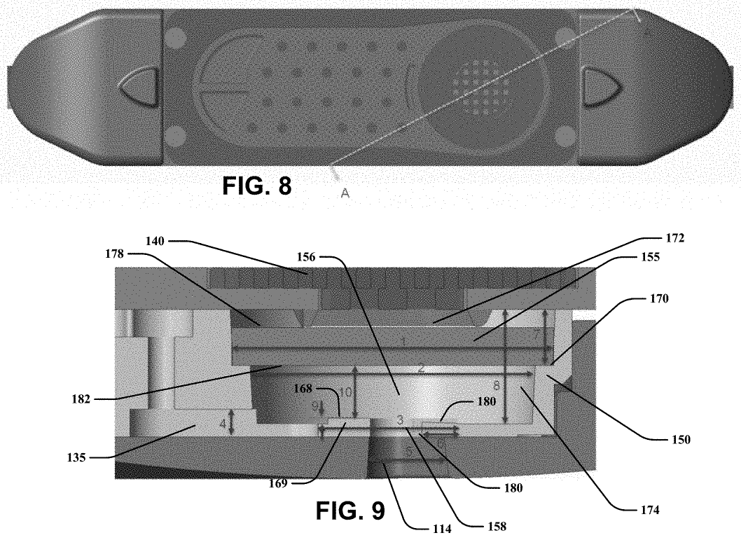

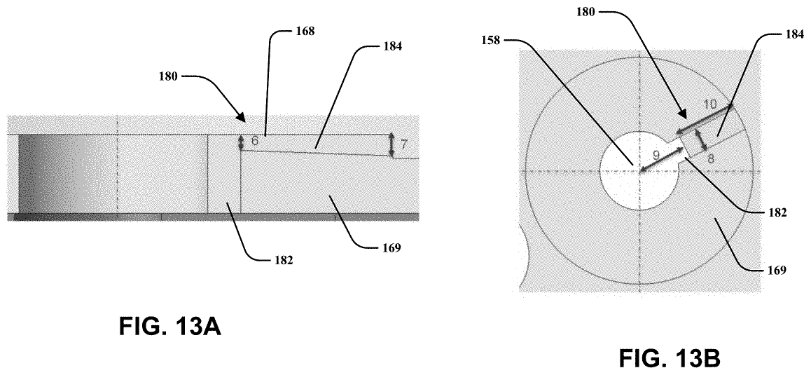

FIGS. 8 illustrates a top view of an optimized embodiment of the structural features of the emitter nozzle assembly of the instant application. FIG. 9 illustrates various structural features of the pressure compensating component of FIG. 9 through line A-A. These features includes: (1) Pocket Diameter which is the dimension of the first zone 172 of the cavity; (2) Shoulder Diameter which is the dimension of the cavity in the second zone 174; (3) Platform Surface Diameter which is the dimension of the platform 169; (4) Inlet Diameter wihc is the height of the outlet lumen 135; (5) Exit Diameter with is the diameter of the outlet 114; (6) Weir Length which is the length of the weir 180 from the outer edge of the platform to an inner notch 182; (7) PC Depth dimension from the shoulder 170 to the underside of the filter component 140; (8) PC Depth 2 dimesnon from the bottom of the cavity 156 to the underside of the filter component 140; (9) PC Depth 3 is the height of the platform 169 from the bottom of the cavity 156; (10) “land height”—which is the optimized feature and is measured as the distance from the disk/diaphragm at rest or neutral to the platform surface 168. Further, FIGS. 13A and 13B illustrates additional structural features related to the weir 180 and platform 169 including: (6) Weir Depth 1; (7) Weir Depth 2; (8) Weir Width; (9) Weir notch 182 from axis; and (10) Length of the Weir.

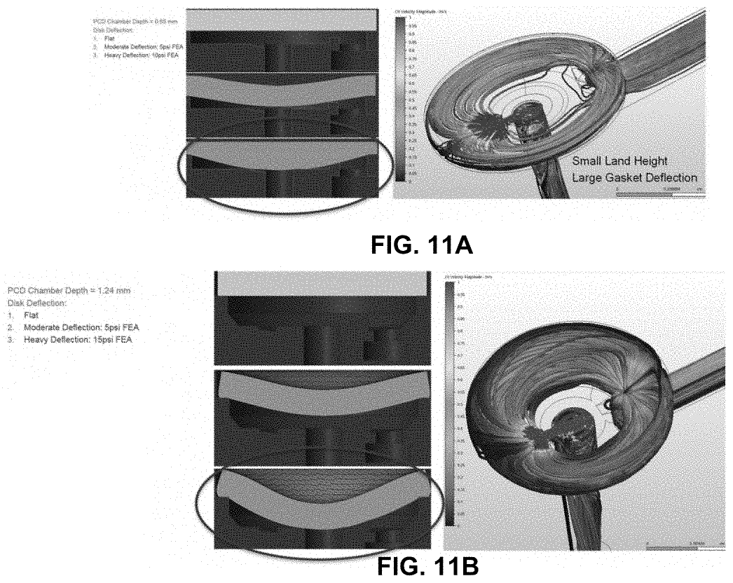

In this embodiment, it has been discovered that an increased land height (item 10 of FIG. 9) provides optimized performance of the pressure compensation component 150. This land height dimension of FIG. 9 may be between about 2× the dimension of known land heights. For example, FIG. 9 may include a land height that is about 1.2 mm or greater (See FIG. 11B—i.e., such as 1.24 mm or 1.43 mm) while prior embodiments of pressure compensating devices were conventionally designed to include a land height dimension that is about 1.1 mm or less (See FIG. 11A—i.e., such as 0.65 mm or even 1.12 mm). Modifying this dimension while maintaining similar dimensional constraints for the remaining features of the pressure compensation component 150 has been identified to be an example of a preferred embodiment of the instant disclosure that optimizes performance by providing a slower, more uniform velocity of fluid flow through the cavity 156 that also allows for larger diaphragm deflection. This optimized feature allows for increase diaphragm deflection distance between the neutral or un-deflected position to an abutted position as the diaphragm abuts against the platform surface 168, a decreased pressure drop across the pressure compensating component 150, an increased pressure drop in the accompanying pressure reduction component 110, and increased flow uniformity throughout the pressure compensating component 150.

Further, through substantial experimentation related to flow rates and grit clog testing, the applicants have discovered that land heights (“10”) less then 1.2 mm or more particularly less than 1 mm exhibit very poor clog resistance which imply that land heights greater than about 1.2 mm may be preferred for optimized performance. Current packaging limitations may prevent the land height dimension from having a significant height but an approximate range for an embodiment of a preferred land height would be between about 1.2 mm to about 1.6 mm or more particularly to about 1.43 mm. There is reason to believe that even land height dimensions larger than about 1.6 mm may also improve clog resistance for optimal performance as long as the sub assembly may still be manufactured to be installed within a tube of a desired diameter and use. In an example, the weir 180 and land height “10” could be packaged in the base 120 or body component such as illustrated by FIG. 5 to allow for a land height of about 2.0 mm. Additionally, the experimentation has suggested that the weir depth “9” of FIG. 9 may be within a dimensional range of between about 0.05 mm to about 0.15 mm to provide additional improved clog performance. The particular geometry of the weir depth “9” may also be considered an optimized feature and dimension within the cavity 156 that improves performance. The geometry of the weir 180 is particularly illustrated by FIGS. 13A and 13B and illustrate that the weir 180 includes an angled floor 184 relative to the landing surface 168 and a notched portion 182 that extends radially outwardly relative to the exit hole 158.

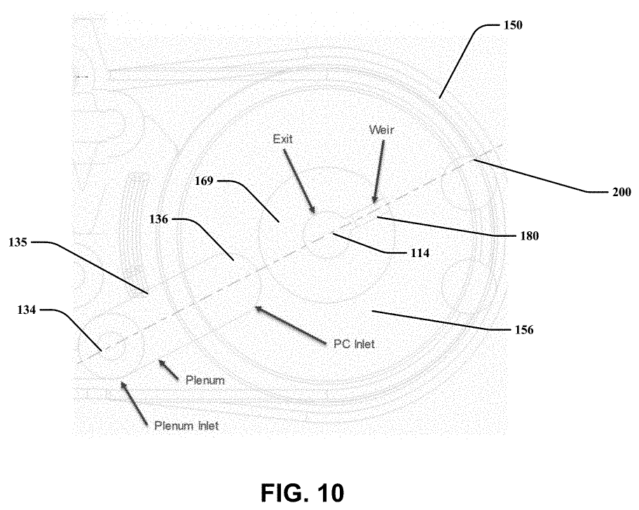

Further, the cavity 156 of the pressure compensating component 150 was found to have optimized functionality when the various features were aligned along a common axis 200 as illustrated by FIG. 10. Here, the outlet lumen 135 or plenum is illustrated to intersect the cavity 156 at an outlet 136 illustrated as the “PC inlet” that is positioned along an opposite side of the outlet 158 “exit” from the weir 180 along the common axis 200. The outlet lumen 135 is defined by a plenum space that extends from a plenum inlet 134 to the outlet 136 or “PC inlet” wherein the geometric configuration of the outlet lumen 135 is generally aligned along the common axis 200. Further, the exit hole 158 “exit” is also aligned along the common axis 200. The weir 180 may include a length that is be positioned to align along the common axis 200 such that once the diaphragm 155 has been deflected to abut against the platform surface 168, fluid flows through zone two 174 around the deflected diaphragm 155 and platform 169 to access the weir 180 and exit through the exit hole 158 and outlet 114. During operation the diaphragm may experience various deflection and the fluid flow may throttle its pressure level as fluid egress through the exit hole 158. This configuration may allow for the proper function and regulation of fluid flow and pressure through the assembly 100 and provide an exponent value of less than about 0.14. Also, if grit were to become lodged in the weir 180 once the diaphragm 155 is deflected against the platform surface 168, pressure within the assembly 100 would cause the diaphragm 155 to deflect back to a neutral position and allow the grit to become dislodged from the weir 180 and exit through the exit hole 158. The fluid pressure within the assembly 100 will then return to is normal operating state.

FIGS. 11A illustrates an experimental performance of an embodiment of a pressure compensating component with a diaphragm wherein the land height is about 0.65 mm and was illustrated to have flat deflection, moderate deflection ad 5psi and heavy deflection at 10 psi of fluid pressure within the system. The flow diagram illustrates the velocity magnitude of a fluid flow through such a low height pressure compensating component. FIG. 11B illustrates the experimental performance of an embodiment of a pressure compensating component with a diaphragm wherein the land height is about 1.24 mm and was illustrated to have flat deflection, moderate deflection ad 5psi and heavy deflection at 10 psi of fluid pressure within the system. A comparison between these two illustrate that the larger land height provides larger diaphragm deflection, gives slower and more uniform velocity flow through the cavity 156 (or “PC pocket) per the colored streamlines.

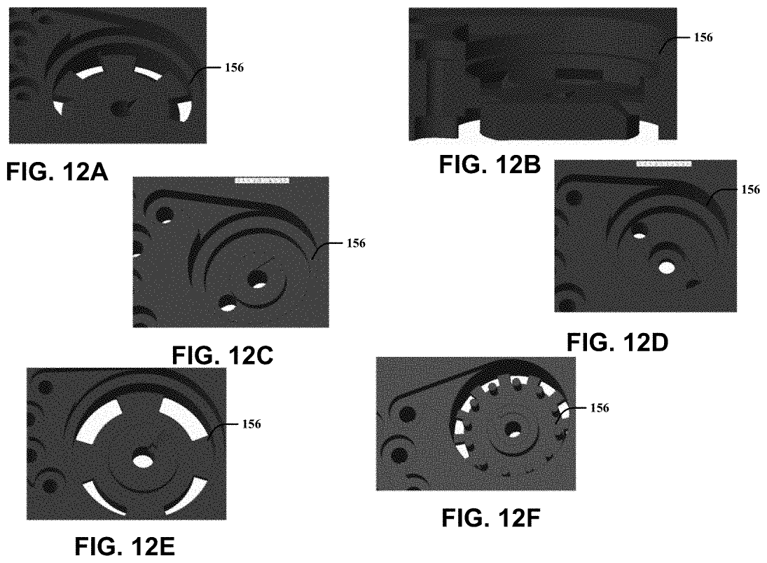

FIGS. 12A through 12F illustrate various embodiments of the pressure compensating component 150 of the instant disclosure. FIGS. 12A and 12B illustrates a weir 180 that is flush to the cavity floor to enable improved flushing along with a spoked inlet to provide smooth fluid transition into the cavity. FIG. 12C illustrates a weir geometry having an angled wall and a curved wall. FIG. 12D illustrates a weir having a dual swirl geometry concept wherein the weirs are sub flus with the floor of the cavity. FIG. 12E illustrates low, medium and high pressure attenuation samples with a spoked inlet geometry. FIG. 12F illustrates a swirl weir concept that includes spoked inlets and posts. FIGS. 13A and 13B illustrate another embodiment of weir geometry illustrating an angled floor relative to the landing surface and a notched portion that extends radially outwardly relative to the outlet.

The emitter nozzle assembly 100 of the present disclosure may be created as an injection molded component. Alternatively, it may be made by additive manufacturing techniques. The diaphragm may be made of silicone. It may include static components, with no moving parts or may be dynamic, having a pressure compensating device to assist with pressure manipulation. The emitter nozzle assembly 100 may be attached to an inner side of the tube 300 and may be inserted and attached as the tube is extruded as part of a drip irrigation system. The drip irrigation assembly's tube 300 may be placed in a farm field and water may be pumped in. The emitter assemblies 100 may take the high pressure flow inside the tube and produce a desired flowrate (selectable depending on the requirements of the environment, terrain or plant being irrigated).

The emitter nozzle assemblies of the present disclosure and the disclosed pressure reducing and compensating elements provide a higher efficiency than traditional pivot, sprinkler, or known emitter systems. The emitters 100 not only provide the appropriate pressure attenuation; they resist clogging from the grit and debris in available ground water. In accordance with the present disclosure, newly developed clog resistant in-line element nozzle irrigation emitter gives a greater pressure attenuation for its physical dimensions than comparable devices in the prior art (as described above).

In an embodiment, the emitter assemblies of the present disclosure may be optimized to fit the following design constraints. It may be configured to be used in both heavy (35-50 mil) and thin (24-30 mil) wall driplines. It has configured to have a 0-0.1 exponent. Include a maximum filtration requirement of 120 mesh for 0.6 and 1.0 LPH circuits, and 80 mesh for circuits above 1.0 LPH. It may display various and adjusted flow rates including: 0.6, 1.0, 1.5, 2.0, and 4.0 LPH. The emitter may be configured to be attached within tubes having variety of inside diameter measurements including but not limited to: ⅝″, ⅞″, 13 mm, 16 mm, 17 mm, 18 mm, 20 mm, and 25 mm. It may also be used with at least one of the following features: a check valve feature, an anti-siphon feature, a self flushing feature. It may have an annual volume of about 100 M w/CV of 3% or less and may be fully pressure compensating from 7-60 Psi. The emitter may be made from polyethylene.

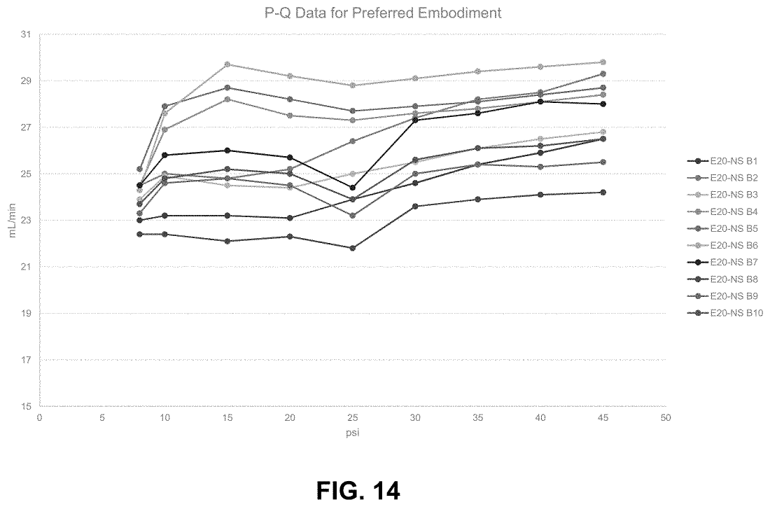

FIG. 14 illustrates a graph that displays various tests of the emitter assembly 100 that includes the pressure compensating component 150 of the present disclosure (FIG. 11). This graph is a P-Q graph that identifies pressure and average flow rate of the measured assemblies 100. This data illustrates that for nine (10) different tests of various prototypes of the present assembly 100 the level pressure (psi) measured at the outlet of the assembly 100 was able to be maintained at a relative constant level over a broad range of flow rates Q (mL/min). Here, each of the measured prototypes maintained a flowrate between about 21 psi to 30 mL/min.

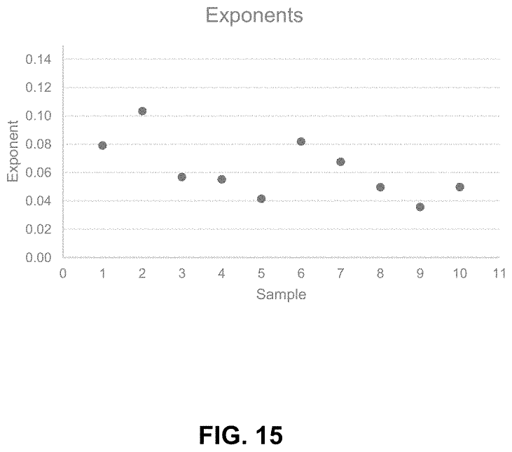

FIG. 15 illustrates a graph that displays the measured Exponent values that corresponds to the various tests of the prototypes of the emitter assemblies 100 identified by FIG. 13. Here each of the tested prototypes were identified to include an exponent value that was less than about 0.14 and was as low as about 0.02. The addition of the pressure reducing component 110 to the pressure compensating component 150 of the instant disclosure gives an exponent of about 0 so that for any change in pressure, the circuit doesn't increase in flow. A lower exponent value is considered better for handling differences in pressure or having wider operating pressure ranges.

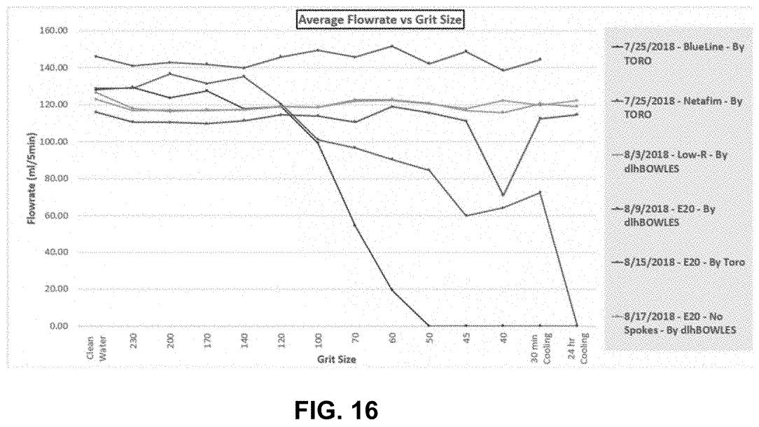

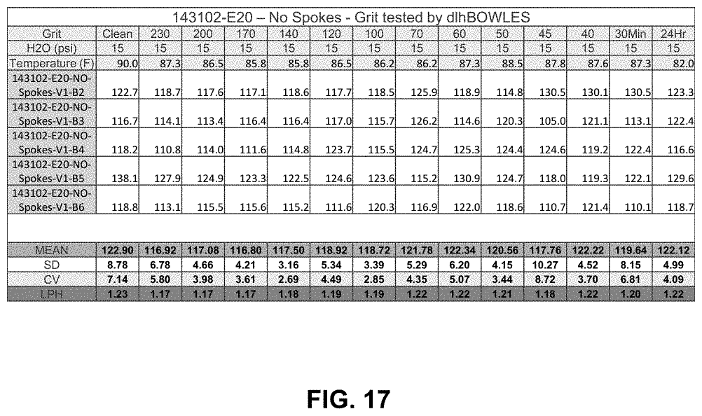

FIG. 16 illustrates a graph that displays average flowrate versus grit size for various type geometries of the pressure compensating component 150 within an emitter nozzle assembly. FIG. 17 illustrates a graph that displays measure grit tests for the various prototypes of emitter nozzle assemblies. This data displays results that each embodiment of the prototypes passed the various grit tests over time. This table of results is an example from an industry standard grit test to measure clog resistance. Water is recirculated through a lateral tube containing several emitters. Sequentially coarser batches of sand or grit (230 being fine, 40 being coarse) are added to the water over the course of about 5 hours. The longer and larger the flowrate each emitter maintains, the better the clog resistance. This table shows that during the periodic sampling of 5 minutes of flowrate, 5 emitters maintain desired output of about 25 mL/min or 1.5 LPH.

The applicants have used a variety of terminology to describe the subject matter of the present disclosure. Many of these terms are related or interchangeable. The following is meant to provide some clarification to this jargon. The present disclosure is largely based on the proportion or ratio of the hydraulic resistance or pressure head loss associated with the two discrete portions of the nozzle flow path. First the pressure reducing portion, commonly denoted as the vortex array or static circuit. Second the pressure compensating portion, commonly denoted as the PCD, PC chamber or dynamic circuit. This second portion is said to be dynamic because its cross section changes with pressure. The pressure entering the static circuit is typically denoted P1. The pressure leaving the static circuit and entering the dynamic circuit is typically denoted P2. The pressure leaving the dynamic circuit is typically denoted P3, and is about equal to atmospheric pressure. The resistance or head loss over the static circuit is then ΔP_{Static}=P1−P2. The resistance or head loss over the dynamic circuit is ΔP_{Dynamic}=P2−P3. The total head loss over the emitter is then ΔP_{Total}=ΔP_{Static}+ΔP_{Dynamic}. The applicants have defined the PC ratio as the ratio of head loss over each of the two discrete portions of the flow path (i.e. ΔP_{static}/ΔP_{Dynamic}). A relatively large PC ratio has been shown to improve clog resistance. The applicants coined the term Low R to signify an emitter that exhibits a large PC ratio—or a large ΔP_{Static} and a small ΔP_{Dynamic}, relative to values typically observed in the current state of the art. The preferred embodiment disclosed herein and in identified at least in FIGS. 8 and 9 exemplifies said Low R configuration.

Stated further, the pressure compensating emitter of the instant disclosure may be used in both heavy (35-50 mil) and thin (24-30 mil) wall driplines. The emitter may have a 0-0.1 exponent. There may be a maximum filtration requirement of 120 mesh for 0.6 and 1.0 LPH circuits, and 80 mesh for circuits above 1.0 LPH. The emitter may be used with a desired range of flow rates including 0.6, 1.0, 1.5, 2.0, and 4.0 LPH and any range inbetween. The emitter may be used with tubes of various sizes including those with an inside diameter of about: ⅝″, ⅞″, 13, 16, 17, 18, 20, and 25 mm. The emitter may be combined for use with a check valve feature, an anti-siphon feature, includes a self flushing feature. The emitter may be used in a system rated for having an annual volume of 100M w/CV of 3% or less. The emitter may be fully pressure compensating from 7-60 Psi. The emitter may be made from polyethylene.

While in accordance with the patent statutes the best mode and certain embodiments of the disclosure have been set forth, the scope of the disclosure is not limited thereto, but rather by the scope of the attached. As such, other variants within the spirit and scope of this disclosure are possible and will present themselves to those skilled in the art.

Although the present embodiments have been illustrated in the accompanying drawings and described in the foregoing detailed description, it is to be understood that the emitter nozzle assemblies are not to be limited to just the embodiments disclosed, but that the systems and assemblies described herein are capable of numerous rearrangements, modifications and substitutions. The exemplary embodiment has been described with reference to the preferred embodiments. Obviously, modifications and alterations will occur to others upon reading and understanding the preceding detailed description. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An emitter nozzle assembly for an in-line irrigation tube comprising:
a backing plate that includes an outlet;
a pressure reducing component that includes an emitter circuit having a plurality of chambers defined along a first side and a second side of a unitary body in fluid communication with one another;
a cover plate that includes a filter component in fluid communication with the pressure reducing component; and
a pressure compensating component in fluid communication with the pressure reducing component and filter component, the pressure compensating component comprising:
a cavity that includes a platform positioned along a base of the cavity, the platform that includes a platform surface, a weir channel, and an exit hole, wherein the exit hole is in fluid communication with the outlet;
a diagram with a first surface and an opposite second surface, the diaphragm is positioned in the cavity and configured to separate the cavity into a first zone adjacent the first surface and in direct fluid communication with the filter component and a second zone adjacent the second surface and in direct fluid communication with the exit hole, the diaphragm configured to deflect between a neutral position and a contact position against the platform surface;
wherein the diaphragm is positioned within the cavity and includes a land height dimension between the second surface and the platform surface that is equal to or greater than at least 1.2 mm when the diaphragm is in the neutral position within the cavity.

2. The emitter nozzle assembly of claim 1, further comprising an outlet lumen that includes an inlet configured to receive fluid from the plurality of chambers of the pressure reducing component and an outlet positioned in the cavity, wherein the outlet lumen provides fluid communication between the pressure compensating component and the pressure reducing component and wherein the inlet and the outlet of the outlet lumen are aligned along a common axis with the exit hole and weir channel of the platform within the cavity.

3. The emitter nozzle assembly of claim 1, wherein the weir channel includes a weir geometry having an angled floor relative to the landing surface and notched portion relative to the outlet.

4. The emitter nozzle assembly of claim 3, wherein the weir channel includes a weir depth within a dimensional range of between about 0.05 mm to about 0.15 mm.

5. The emitter nozzle assembly of claim 1, wherein the backing plate includes a cavity that is shaped and configured to receive and support the pressure reducing component within the cavity.

6. The emitter nozzle assembly of claim 1, wherein each of the plurality of chambers of the emitter circuit includes an inlet region, a power nozzle, an interaction region and a throat having dimensions to create a pressure drop of fluid flow therein;

7. The emitter nozzle assembly of claim 1, wherein said emitter nozzle assembly is configured to be attached to an inner surface of an in-line irrigation tube.

8. An in-line irrigation tube system comprising a plurality of emitter nozzle assemblies of claim 1, further comprising a tube having an inner surface wherein the plurality of emitter nozzle assemblies are positioned along said inner surface of said tube.

9. An emitter nozzle assembly for an in-line irrigation tube comprising:
a backing plate that includes an outlet;
a pressure reducing component that includes a body with an emitter circuit defined therein having a multi-lumen flow channel between and inlet and an outlet providing fluid communication between the inlet and the outlet wherein said body is configured as a double-sided circuit and a plurality of chambers with lumens aligned in series;
a cover plate that includes a filter component in fluid communication with the pressure reducing component; and
a pressure compensating component in fluid communication with the pressure reducing component and filter component, the pressure compensating component comprising:
a cavity that includes a platform positioned along a base of the cavity, the platform that includes a platform surface, a weir channel, and an exit hole, wherein the exit hole is in fluid communication with the outlet of the backing plate;
a diagram with a first surface and an opposite second surface, the diaphragm is positioned in the cavity and configured to separate the cavity into a first zone adjacent the first surface that is in direct fluid communication with the filter component and a second zone adjacent the second surface that is in direct fluid communication with the exit hole, the diaphragm configured to deflect between a neutral position and a contact position against the platform surface; and
an outlet lumen that includes an inlet configured to receive fluid from the plurality of chambers of the pressure reducing component and an outlet positioned in the cavity, wherein the outlet lumen provides fluid communication between the pressure compensating component and the pressure reducing component and wherein the inlet and the outlet of the outlet lumen are aligned along a common axis with the exit hole and weir channel of the platform within the cavity.

10. The emitter nozzle assembly of claim 9, wherein the diaphragm is positioned within the cavity and includes a land height dimension between the second surface and the platform surface that is equal to or greater than at least 1.2 mm when the diaphragm is in the neutral position within the cavity.

11. The emitter nozzle assembly of claim 9 wherein the emitter nozzle assembly is configured to be attached to an inner surface of an in-line irrigation tube such that the outlet of the backing plate is aligned with a through hole of the irrigation tube to allow a flow of fluid to be dispensed therefrom.

12. An in-line irrigation tube system comprising a plurality of emitter nozzle assemblies of claim 9, further comprising a tube having an inner surface wherein the plurality of emitter nozzle assemblies are positioned along said inner surface of said tube.

13. The emitter nozzle assembly of claim 9, wherein the weir channel includes a weir geometry having an angled floor relative to the landing surface and notched portion relative to the outlet.

14. The emitter nozzle assembly of claim 13, wherein the weir channel includes a weir depth within a dimensional range of between about 0.05 mm to about 0.15 mm.

15. The emitter nozzle assembly of claim 9, wherein the backing plate includes a cavity that is shaped and configured to receive and support the pressure reducing component within the cavity.

14. The emitter nozzle assembly of claim 9, wherein each of the plurality of chambers of the emitter circuit includes an inlet region, a power nozzle, an interaction region and a throat having dimensions to create a pressure drop of fluid flow therein.

17. The emitter nozzle assembly of claim 1, wherein said emitter nozzle assembly is configured to be attached to an inner surface of an in-line irrigation tube.

18. An emitter nozzle assembly for an in-line irrigation tube comprising:
a backing plate that includes an outlet;
a pressure reducing component that includes an emitter circuit having a plurality of chambers defined along a first side and a second side of a unitary body in fluid communication with one another;
a cover plate that includes a filter component in fluid communication with the pressure reducing component; and
a pressure compensating component in fluid communication with the pressure reducing component and filter component, the pressure compensating component comprising:
a cavity that includes a platform positioned along a base of the cavity, the platform that includes a platform surface, a weir channel, and an exit hole, wherein the exit hole is in fluid communication with the outlet;
a diagram with a first surface and an opposite second surface, the diaphragm is positioned in the cavity and configured to separate the cavity into a first zone adjacent the first surface and in direct fluid communication with the filter component and a second zone adjacent the second surface and in direct fluid communication with the exit hole, the diaphragm configured to deflect between a neutral position and a contact position against the platform surface;
wherein the weir channel includes a weir geometry having an angled floor relative to the landing surface and a notched portion that extends radially outwardly relative to the outlet.

19. The emitter nozzle assembly of claim 18 wherein the weir channel includes a weir depth within a dimensional range of between about 0.05 mm to about 0.15 mm.

20. The emitter nozzle assembly of claim 18 further comprising an outlet lumen that includes an inlet configured to receive fluid from the plurality of chambers of the pressure reducing component and an outlet positioned in the cavity, wherein the outlet lumen provides fluid communication between the pressure compensating component and the pressure reducing component and wherein the inlet and the outlet of the outlet lumen are aligned along a common axis with the exit hole and weir channel of the platform within the cavity.

21. The emitter nozzle assembly of claim 18, wherein the diaphragm is positioned within the cavity and includes a land height dimension between the second surface and the platform surface that is equal to or greater than at least 1.2 mm when the diaphragm is in the neutral position within the cavity.
